(19) United States
(12) Patent Application Publication
(10) Pub. No.: US 2026/0227595 A1
(43) Pub. Date: Aug. 6, 2026

(54) REFLECTION DEVICE FOR A HEAD-UP DISPLAY, SPRING ELEMENT, BEARING RETAINER, HEAD-UP DISPLAY AND MOTOR VEHICLE

(71) Applicant: Valeo Schalter und Sensoren GmbH, Bietigheim-Bissingen (DE)

(72) Inventors: Vishal Kulkarni, Bietigheim-Bissingen (DE); Werner Killguss, Bietigheim-Bissingen (DE)

(73) Assignee: Valeo Schalter und Sensoren GmbH, Bietigheim-Bissingen (DE)

(21) Appl. No.: 19/153,179

(22) PCT Filed: Jan. 30, 2024
(86) PCT No.: PCT/EP2024/052133

§ 371 Date: Aug. 1, 2025

(30) Foreign Application Priority Data
Feb. 2, 2023 (DE) 10 2023 102 534.1

(51) Int. Cl. G02B 7/182; G02B 27/01

(52) U.S. Cl. CPC G02B 7/1821; G02B 27/0149; G02B 2027/0154

(57) ABSTRACT

Described is a reflection device for a head-up display, a bearing retainer, a spring element, a head-up display, and a vehicle. The reflection device includes a reflection element and a mount. The reflection element is movably coupled to the mount by means of a bearing such that the reflection element is pivotable relatively vis-à-vis the mount about a first axis. The bearing includes a bearing pin and a bearing retainer. One of the bearing pin or the bearing retainer is securely fastened to the reflection element, and the other of the bearing retainer or the bearing pin is securely fastened to the mount. The bearing retainer includes a spring element which is or has a spring cage, or which is designed in the style of a spring cage.

The present invention relates to a reflection device, in particular a mirror device, for a head-up display, in particular for a windshield head-up display, for reflecting radiation emitted by an image generation unit, wherein the reflection device comprises a reflection element which has a reflection side and a rear side which is arranged on the side facing away from the reflection side, and a mount which at least partially supports the reflection element. The reflection element is movably coupled to the mount by means of at least one bearing in such a way that the reflection element can be pivoted about at least a first axis relatively vis-à-vis the mount. At least one bearing comprises at least two parts: a bearing journal and a bearing retainer for receiving the bearing journal, wherein the bearing journal has an at least partially convexly spherical, spherical and/or hemispherical outer surface or a spherical end or a spherical surface or the like as bearing surface, and wherein the bearing retainer is designed to at least partially receive the bearing journal. One of the parts, the bearing journal or the bearing retainer, is immovably attached to the reflection element and the other, the bearing retainer or the bearing journal, is immovably attached to the mount. The bearing holder has a spring element or is at least partially designed as a spring element.

Furthermore, the present invention relates to a spring element for a bearing retainer for receiving a reflection element of a reflection device for a head-up display, in particular for a windshield head-up display.

The present invention also relates to a bearing retainer for receiving a reflection element of a reflection device for a head-up display, in particular for a windshield head-up display.

The present invention further relates to a head-up display, in particular for a motor vehicle, comprising an image generating unit for emitting light beams to generate an image, and comprising at least one reflection device for reflecting the light beams emitted by the image generating unit.

The present invention also relates to a motor vehicle having a head-up display.

Reflection devices for head-up displays and head-up displays in general, in particular for motor vehicles, are generally known from the prior art. Head-up displays usually comprise an image generation unit that generates an image and a reflection device for projecting this image, for example onto a combiner as a kind of screen or directly onto a windshield of the motor vehicle, wherein the image preferably is projected in the viewing direction of a driver of the motor vehicle, in particular in such a way that the driver can see the projected image when looking at the combiner or the windshield without moving his head and/or without changing a viewing direction.

Due to the different sizes and proportions of different riders, it is advantageous if the position of the projection can be changed in such a way that the projection can be adapted to different riders or to riders of different sizes. For this purpose, head-up displays often comprise a mirror arranged in a beam path or in an optical path of the image generation unit, which is movable, in particular pivotable to be tilted, possibly adjustable by an actuator device, to adjust the position of the projected image, in particular to adjust the position of the projected image to a so-called “eyebox” of a driver.

In order to project high-quality images, in particular sharp and clear images, onto the combiner or the windshield and thus into the driver's field of vision, the support of the reflection element or the mirror and the design of the bearings, with the aid of which the reflection element or the mirror can be pivoted about the first axis, are crucial.

Head-up displays with movable, in particular pivotable mirrors are generally known from the prior art, for example from FR 3 023 926, US 2019/0219823 A1 , US 2020/0338944 A1 or DE 10 2020 132 549 A1 , wherein various designs are known, in particular different designs and arrangements with regard to the pivotable mounting.

Against this background, it is an object of the present invention to provide an alternative reflection device, preferably a reflection device with an improved mounting of the reflection element.

Furthermore, it is an object of the present invention to provide an alternative spring element, an alternative bearing retainer and an alternative head-up display with a reflection device, preferably an improved head-up display. It is also an object of the present invention to provide an alternative motor vehicle with a head-up display, preferably an improved motor vehicle.

These objects are achieved by a reflection device, by a spring element, by a bearing retainer, by a head-up display and by a motor vehicle having the features in accordance with the respective independent claims. Advantageous embodiments of the invention are the subject matter of the dependent claims, the description and the figures.

A reflection element according to the invention is characterized in that the spring element of the bearing retainer is or has a spring cage or is designed in the style of a spring cage.

A “spring cage” within the meaning of the present application is in particular a spring element which has a cage-like form or which is designed in the style of a resilient cage, or a spring element which acts like a spring cage.

Furthermore, a reflection device designed in this way, in particular with a bearing designed in this way, enables precise mounting and guidance of the bearing journal on the one hand and sufficient preload in the axial direction on the other. This allows a good image quality of the projected image to be achieved with a particularly simple bearing design, especially with a particularly simple bearing retainer. Furthermore, a very space-saving bearing retainer can be provided that requires very little space and components.

In a particularly advantageous embodiment, at least one bearing holder is designed in such a way that the associated spring element of the bearing holder serves at least partially to guide the bearing journal. This makes it possible to provide a very space-saving bearing retainer that requires only a small amount of space and components. By integrating the spring-support function into the bearing retainer, a very compact bearing retainer can be provided. Furthermore, a sufficiently rigid, but at the same time sufficiently flexible bearing support can be achieved with simple means and little effort. In particular, this makes it possible to realize a bearing retainer requiring only a few components, with which in particular a high radial and/or tangential rigidity can be achieved in relation to the first axis as the axis of rotation or pivot axis, while at the same time providing sufficient compliance in the axial direction along the first axis.

Compared to a spiral spring, for example, the cage-like design of the spring element has the advantage that the spring element with this design can at least partially surround the bearing journal, in particular if this is at least partially convexly spherical or similar. This makes it easy to provide a particularly simple bearing retainer with advantageous properties, in particular a bearing retainer which on the one hand enables good and precise guidance of the bearing journal and with which on the other hand sufficient bearing rigidity can be achieved.

In a particularly advantageous, possible embodiment, the spring element, preferably the spring cage, can therefore in particular have an at least partially concave spherical, hollow spherical and/or hollow hemispherical inner surface or a hollow spherical end or a hollow spherical surface or the like as a bearing surface, against which in particular the bearing journal can at least partially abut with its outer surface. As a result, particularly good guidance of the bearing journal can be achieved, especially in the radial direction in relation to the first axis and thus when pivoting the reflection element about the first axis. In particular, the geometry of at least one bearing surface of the bearing retainer can at least partially correspond to the geometry of the outer surface of the bearing journal. In particular, an inner surface or inner envelope curve or surface of the spring cage can at least partially correspond to the outer surface of an associated bearing journal.

In particular, the spring element can be designed in such a way that it is resilient in the axial direction of the first axis, in particular sufficiently resilient and compliant to avoid distortion of the reflection element.

At least one bearing of the reflection device can be arranged on the rear side of the reflection element in such a way that the first axis runs completely behind the rear side of the reflection element. This not only makes it possible to achieve smaller dimensions in the lateral direction, but also a reflection device without visible connection interfaces or bearings in the optical chamber.

With an arrangement of the first axis completely on the rear side of the reflection element, i.e., with a first axis that does not (virtually) pierce or penetrate the reflection element, a small lever from the center of gravity of the reflection element to the first axis can also be achieved in particular. This is advantageous with regard to the vibration behavior of the reflection element.

A “reflection element” according to the present invention is an element, in particular a component or a group of composite components, which is designed to reflect and/or influence radiation, for example to change a direction, in particular of light or of one or more light beams, and thereby in particular of one or more parts of an image or of an image as a whole.

A “mount” according to the invention is preferably a load-bearing structure. A mount within the meaning of the present invention can in particular be coupled to a housing or attached to a housing, in particular to a housing of a head-up display. Alternatively, the mount can be formed by a housing or part of a housing, for example the housing of a head-up display. As a result, a reflection element of a reflection device according to the present invention or a reflection element assembly may, for example, be coupled directly to a housing of a head-up display, wherein the housing is the “mount”, or via a separate receiving or supporting structure, wherein in this case the separate receiving or supporting structure is the “mount”.

According to the present invention, the “reflection side” of the reflection element is the side of the reflection element, in particular the surface of the reflection element, which is designed to reflect and/or influence the radiation.

In a preferred embodiment of the present invention, the reflection device may in particular be adapted and designed to reflect or optically influence an image generated by an image generating unit, wherein the image may for example contain one or more navigation information, a vehicle speed information or any other information which may be an interesting information for a driver of a vehicle, as is known from the prior art.

The reflection device may be adapted and configured for use in a head-up display comprising a combiner, wherein the reflection device is configured to project an image onto the combiner. Additionally or alternatively, the reflection device may be adapted and configured for use in a windshield head-up display, wherein the reflection device is configured to project an image onto the windshield.

Both types of head-up displays, head-up displays with combiners and windshield head-up displays, are generally well known from the prior art, to which reference is hereby made for further details on general design and/or functionality aspects of such head-up displays.

In a preferred embodiment of a reflection device according to the present invention, the first axis is a horizontal axis based on a state of use of the reflection device. The reflection element can be inclined by means of a first, horizontally aligned axis, for example to align the reflection element with a windshield of a motor vehicle, in particular with the inclination of the windshield.

In a preferred embodiment of a reflection device according to the present invention, the reflection element is preferably a mirror element, in particular a concave mirror element, which has a concave reflection side. To minimize weight and installation space requirements, the reflection element is preferably shaped as a thin shield.

In addition, only the reflection side or the entire reflection element can be curved, wherein the curvature can correspond in particular to the curvature of the windshield of the vehicle for which the reflection device is intended. In particular, the reflection element can be a so-called “free-form” reflection element, which has a concave shape with a non-constant radius. The reflection element can also be designed as an enlarging mirror.

In a very advantageous embodiment of a reflection device according to the present invention, the first axis can in particular be aligned parallel to a main optical axis of the reflection element.

The outer edge of the reflection element can be substantially rectangular, so that the reflection element has a substantially rectangular outer contour in particular. Alternatively, the outer edge can have a different shape, for example a trapezoidal or oval or elliptical shape or the shape of a square.

In an advantageous embodiment of a reflection device according to the present invention, the reflection element may comprise glass or be made of glass. A reflection element made of glass, a glass mirror for example, has the advantage that it has a better optical quality and is more stable over a temperature range compared to a reflection element made of plastic. In addition, smaller mirror thicknesses can be realized when using glass as a reflection element material.

However, in some cases an alternative configuration of the reflection device comprising a reflection element made at least partly or entirely of plastic may be more advantageous, for example when a lower image projection quality is sufficient or when a target weight of the reflection device cannot be achieved with a reflection element made of glass.

The reflection element can comprise a coating, in particular a reflective coating, which can be a metal coating or a metal-containing coating. This allows advantageous reflection and/or projection properties to be achieved.

In an advantageous embodiment of a reflection device according to the present invention, the reflection side of the reflection element may be a uniform or smooth surface, meaning a surface which is free of any protrusion and/or depression. This allows advantageous reflection and/or projection properties to be achieved.

In an advantageous embodiment of a reflection device according to the present invention, the rear side of the reflection element may additionally or alternatively be a uniform or smooth surface. This makes it easy to produce the reflection element. In particular, no work steps are required to create any protrusion or recess.

In a further advantageous embodiment of a reflection device according to the present invention, the bearing journal has an at least partially spherical and/or hemispherical outer surface or a spherical end or a spherical surface or the like as a bearing surface, with which the bearing journal bears against or slides on a bearing surface of the bearing retainer. This allows for a bearing design that is very easy to install with advantageous functionality, especially with low bearing friction.

If at least one bearing part is made of plastic, the bearing can be designed as a dry bearing, i.e., as a bearing for which no additional lubricant is required. In some cases, it can be helpful for sufficient lubrication if the material from which the bearing is made comprises lubricating particles and/or if at least one sliding zone of the at least one bearing comprises a friction-reduced surface, which can be formed, for example, by a friction-reduced coating.

In a possible, advantageous embodiment of a reflection device according to the present invention, the reflection element can in particular be rotatably coupled to the mount by at least two bearings, in particular a first bearing and a second bearing, wherein each bearing has a kinematic point and the kinematic points of the bearings define the first axis about which the reflection element is rotatable relatively vis-à-vis the mount. In particular, the first bearing and the second bearing can each comprise two parts: a bearing journal and a bearing holder for receiving the bearing journal. In particular, the bearing journal can have an at least partially convex spherical, spherical and/or hemispherical outer surface or a spherical end or a spherical surface or the like as a bearing surface. The bearing holder can be designed to at least partially accommodate the bearing journal. One of the parts, the bearing journal or the bearing retainer, can in particular be immovably attached to the reflection element and the other part, the bearing retainer or the bearing journal, can be immovably attached to the mount. In particular, the bearing retainer can each have a spring element or be at least partially designed as a spring element. In other words, in an advantageous embodiment, both bearing retainers in particular can each have a spring element. In particular, the spring element of the bearing retainer can be or have a spring cage or be designed in the form of a spring cage.

This makes it possible to achieve an advantageous mounting of a reflection element that can be rotated about a first axis in a particularly simple and, in particular, space-saving manner, which also makes it possible to achieve good projection quality.

In a particularly advantageous embodiment according to the present invention, at least the spring element and/or the bearing receptacle of the first bearing and the second bearing are at least partially identical, in particular completely identical, i.e., the same. This can re-duce the number of identical parts in the reflection device and thus the number of different components, which has a beneficial effect on the complexity of the reflection device and on the costs. In particular, the first bearing retainer and the second bearing retainer can be identical and/or the first bearing and the second bearing can be identical. In principle, however, only the bearing journals can be at least partially identical and the bearing retainers can be different. However, it is particularly advantageous if the first bearing and the second bearing are designed identically.

A “kinematic point of a bearing” in the sense of the present invention is in particular that point of the associated bearing to which a real movement in the bearing can be reduced or idealized with sufficient accuracy, for example for simulation purposes.

In a further possible, advantageous embodiment of a reflection device according to the present invention, at least one spring cage can have a main spring direction and be arranged in the holder in such a way that its main spring direction is aligned with the first axis about which the reflection element is pivotable. This is a simple way to achieve spring support only in the longitudinal direction of the first axis, but still achieve sufficient rigidity in the radial and tangential direction in relation to the bearing journal or the first axis as the axis of rotation.

In a further possible, advantageous embodiment of a reflection device according to the present invention, at least one spring element, in particular the spring cage, can have or be a conical coil spring or be designed in the style of a conical coil spring. This allows an advantageous spring element to be realized in a particularly simple way, especially a spring element that also enables the guidance of an associated bearing journal. This design is very simple and cost-effective. In this case, the spring element is particularly made of metal or at least partially contains a metallic material, in particular spring steel.

In principle, however, at least one spring element can also be made of plastic or manufactured from it, in particular by injection molding. To ensure sufficient rigidity, a plastic should be selected that enables a bearing preload in at least one spatial direction of at least 50 N, preferably at least 75 N, in particular at least 100 N.

In the case of a conical spiral spring, this can be arranged in particular in such a way that the end with the larger internal diameter of the conical spiral faces the reflection element and the end with the smaller internal diameter of the conical spiral faces away from the reflection element.

In a further possible, advantageous embodiment of a reflection device according to the present invention, a bearing retainer can also have more than one spring element or have or be a combination of spring elements.

As an alternative to a conical spiral spring, for example, at least one bearing retainer can also have or be at least one plate spring or a plate-spring-like element or a spring element designed at least partially in the style of a plate spring, wherein such a spring element is arranged in particular in such a way that an associated plate plane extends substantially in the radial direction perpendicular to the axis of rotation of the reflection element.

In a further possible, advantageous embodiment of a reflection device according to the present invention, in particular in a possible further development, the bearing journal of at least one bearing can in particular project at least partially into the associated spring cage of the associated bearing retainer.

In particular, at least one bearing journal can be operatively connected to the bearing retainer, in particular to the spring cage, in such a way that a spring force can be generated by an axial displacement of the bearing journal along the first axis in at least one direction, starting from at least one reference position, in particular in the event of an axial displacement in the direction of the housing or vehicle body.

In a further possible, advantageous embodiment of a reflection device according to the present invention, at least one bearing can have a bearing retainer which is designed, formed and aligned in such a way that a mounting direction along which the bearing journal is at least partially inserted into the bearing retainer or can be inserted during mounting runs at least substantially parallel or parallel to the first axis of the reflection device.

This enables a particularly simple and, for the desired function, very effective design of a bearing for rotatably mounting a reflection element about a first axis in a reflection device. This also makes it easy to install the bearing.

In a further possible, advantageous embodiment of a reflection device according to the present invention, the bearing journal of at least one bearing can be at least partially inserted into the spring cage in the axial direction of the first axis.

On the one hand, a bearing designed in this way enables precise mounting and guidance of the bearing journal in a radial and tangential direction (in relation to the first axis as the rotation or pivot axis). On the other hand, the spring cage enables small compensating movements in the axial direction. As a result, this allows a good image quality of the projected image to be achieved with a particularly simple bearing design, especially with a particularly simple bearing retainer.

In a further possible, advantageous embodiment of a reflection device according to the present invention, at least one bearing retainer can be accommodated by the mount, wherein the mount can in particular have a mount retainer for this purpose, into which the bearing retainer can be inserted. This makes it easy to achieve a precise positioning and/or simple and secure attachment of the bearing retainer to the mount.

In a further possible advantageous embodiment of a reflection device according to the present invention, the bearing holder can be inserted into the mount retainer by a translational movement in a plane extending perpendicular to the first axis. This makes it particularly easy to fit an associated reflection device.

In particular, at least one bearing retainer can have a pocket-, or box-or crate-like configuration with at least one, in particular two, at least partially open sides for receiving and/or inserting the spring element, wherein a first open side in particular enables insertion of the spring element as described above and a second open side in particular enables at least partial insertion of the bearing journal into the bearing retainer or the spring element inserted therein in the axial direction along the first axis.

The bearing receptacle and/or the bearing journal can be made of plastic or any other material or comprise such a material. However, for weight reasons, the bearing retainer and/or the bearing journal are preferably made at least partially from plastic, in particular from a plastic that has a high rigidity, such as polyamide.

In a further possible, advantageous embodiment of a reflection device according to the present invention, the bearing retainer can be fastened in the mount retainer by means of a screw connection, for example. Alternatively or additionally, the bearing holder can also be held or fixed in position by an adhesive connection and/or a snap-in connection and/or a frictionally engaged connection, i.e., by means of a press connection.

In one possible embodiment, the bearing retainer can also be integrated into the mount, in particular be formed in one piece with it, in particular have been manufactured together in an injection molding process. In this case, however, the associated spring element is preferably designed separately from the bearing retainer to enable simple assembly.

In one possible embodiment, the spring element and the bearing retainer can also be manufactured integrally, i.e., in one piece. In this case, however, the bearing holder is preferably designed separately from the mount to enable simple assembly.

In a further possible advantageous embodiment of a reflection device according to the present invention, the reflection device may comprise at least one preload means for generating at least one preload force to hold the reflection element in a defined position in an assembled state of the reflection device and/or to reduce the risk of vibrations of the reflection element. In particular, the preload means can be arranged on a rear side of the reflection element.

Such a preload means can in particular be a spring element, in particular a longitudinal spring element, for example a spiral spring, which is attached with one end to the rear of the reflection element, for example to the mount or to the reflection element itself, in particular via a corresponding fastening device, and which is attached with the other end, for example to the housing of the reflection device and/or to the vehicle body. Depending on the design of the spring element and its orientation in space, a preload force can be applied in the desired direction, in particular to the reflection element. This can further stabilize the reflection element and improve the projection quality even more.

At least one preload means can be designed to generate at least one preload force in an axial direction parallel to or along the first axis in an assembled state of the reflection device, preferably in order to hold the reflection element in a defined position in the axial direction along the first axis after assembly of the reflection device, in particular for preloading a bearing journal against an end stop of an associated bearing holder which has such an end stop. This allows tolerances to be compensated for in at least one bearing. In particular, this can reduce or eliminate play in at least one bearing in the direction of the pre-load effects, which leads to improved vibration and adjustment behavior of the reflection element and, as a result, to improved image projection quality.

The preload means can be designed and/or arranged as a “1D preload means”, i.e., as a preload means that generates a preload force that only extends in one of the spatial directions X, Y or Z. Such a 1D preload means can be a coil spring, for example, which is arranged with its longitudinal axis parallel to or along the first axis.

Alternatively, the preload means can be a “2D or 3D preload means”, i.e., a preload means that generates a 2D or 3D preload force that extends in at least two, in particular in all three spatial directions X, Y and Z. As a result, play in at least one bearing can be reduced or eliminated in at least two or all spatial directions X, Y and Z, which leads to improved vibration and adjustment behavior of the reflection element in the additional pre-load direction as well (compared to a 1D preload element) and consequently to improved image projection quality.

In one embodiment of a reflection device according to the present invention, the reflection device may comprise more than one preload means.

In general, the preload means can be designed, constructed and/or arranged as a com-pression preload means or as a tension preload means, depending on the design and arrangement of the reflection device, in particular depending on the at least one bearing. Depending on the direction(s) and a level of the preload force(s) generated, play in the respective direction(s) can be reduced or eliminated. The reduced play(s) leads to improved vibration and adjustment behavior of the reflection element. Consequently, an improved image projection quality can be achieved.

A spring element according to the present invention for a bearing retainer for receiving a reflection element of a reflection device for a head-up display, in particular for a windscreen head-up display, wherein the reflection device is designed to reflect radiation emitted by an image generation unit, characterized in that it is designed to produce a reflection device according to the present invention.

A bearing retainer according to the present invention for receiving a reflection element of a reflection device for a head-up display, in particular for a windscreen head-up display, wherein the reflection device is designed to reflect radiation emitted by an image generation unit, is characterized in particular in that it is designed to produce a reflection device according to the present invention, wherein the bearing retainer has in particular a spring element which is designed according to the present invention.

A head-up display according to the present invention, in particular for a motor vehicle, comprises an image generating unit for emitting light beams to generate an image, and at least one reflection device for reflecting the light beams emitted by the image generating unit, and is characterized in that the reflection device is designed according to the present invention.

Head-up displays are generally well known from the prior art, to which reference is hereby made for further details regarding general design and/or functional aspects of a head-up display according to the present invention.

The image generation unit is used in particular to generate an image that can be perceived by a driver of the vehicle. This can be realized, for example, by emitting light radiation to display the image from the image generation unit. The image generation unit can be arranged in a housing of the head-up display.

A head-up display according to the present invention may comprise one or more reflection devices, wherein at least one reflection device may comprise one or more reflection elements pivotally coupled to a mount as described above, wherein the one or more reflection elements may be coupled to a common mount or to several different mounts, which means that a head-up display according to the invention may also comprise several mounts.

The at least one rotatably mounted reflection element serves in particular to deflect the light beams generated and emitted by the image generation unit and is preferably arranged directly behind the image generation unit in the beam direction of the light radiation emitted by the image generation unit. The light radiation can be directed from this reflection element through a housing of the head-up display or through an opening in the housing of the head-up display into a driver's field of vision.

The projection surface onto which the generated image can be projected can be a windshield of a vehicle, for example the windshield of a motor vehicle, or a separate combiner screen, which can be part of a head-up display according to the invention and which is preferably arranged so that it can be viewed by the person for whom the image is generated, who can be, for example, a driver of a motor vehicle. The projection surface can be a semi-transparent reflective surface, in particular a mirror surface.

In an advantageous embodiment of a head-up display according to the present invention, the head-up display is designed such that the generated image can be superimposed in a manner known per se with information appearing through the projection surface from an environment located behind the projection surface, whereby an image with additional information is generated. In particular, a head-up display according to the invention can be a so-called “augmented reality head-up display (AR head-up display)” or a so-called “reality head-up display (VR head-up display)” or a combination thereof, wherein the head-up display is designed to display an augmented reality image or a reality image.

In order to provide a driver of a vehicle, in particular a motor vehicle, with a good view of the image depending on the seat position or depending on the size of the driver, a field of vision of the driver, which is also referred to as an “eyebox”, can be tracked, in particular by the head-up display, which can therefore preferably be designed accordingly and which can in particular comprise additional elements, for example several corresponding sensor elements and at least one control unit for determining the position, orientation and/or size and/or dimension of the eyebox.

In a further advantageous embodiment of a head-up display according to the present invention, the output light reflected by the reflection device can track the eyebox and thus a viewing direction of the driver, which can be realized by means of an adjustment device and/or corresponding kinematics acting on the reflection element of the reflection device.

For adjusting the reflection element, in particular for pivoting or rotating about the first axis, the reflection device and/or the head-up display can comprise a pivot drive unit, in particular a linear pivot drive unit, which can be coupled in particular to the reflection element, preferably via a support structure by which the reflection element is held and coupling means, such as a pivot arm. Preferably, the pivot drive unit is designed and configured to pivot the reflection element about the first axis by linear actuation, in particular by linear actuation orthogonal to the first axis.

In an advantageous embodiment of a reflection device according to the present invention, the support structure can be designed in particular as a shield or as a shield-shaped frame, wherein the support structure preferably comprises a mounting side and a rear side. In particular, the support structure can be designed and arranged in such a way that its mounting side faces the rear of the reflection element and extends at least partially parallel to the reflection element, in particular to its reflection side and/or its rear. This allows a very compact design of the reflection device. This makes it possible to provide a reflection device which has only a small spatial requirement.

A motor vehicle according to the present invention has a head-up display and is characterized in that the head-up display is designed according to the present invention.

The preferred embodiments presented in relation to a reflection device according to the present invention and their advantages apply correspondingly to a spring element, a bearing retainer, to a head-up display according to the present invention and to a motor vehicle according to the present invention and vice versa, if technically possible.

Further features of the invention emerge from the claims, the figures, and the description of the figures. The features and combinations of features mentioned above in the description and the features and combinations of features mentioned below in the description of the figures and/or shown in isolation in the figures can be used not only in the combination specified in each case, but also in other combinations or alone, provided the resultant combination is practicable.

The individual aspects of the present invention will now be explained in more detail with reference to a preferred but non-limiting exemplary embodiment and with reference to the accompanying schematic drawings, which are not to scale, wherein functionally identical parts or components or assemblies are each provided with the same reference sign.

In the Drawings:

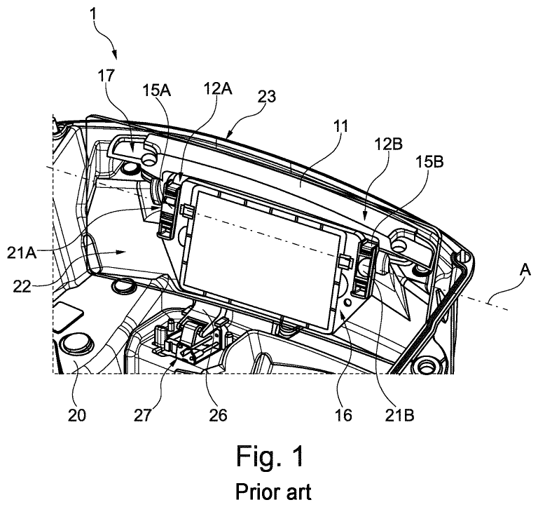

FIG. 1 is a perspective view of a detail of a reflection device known from the prior art,

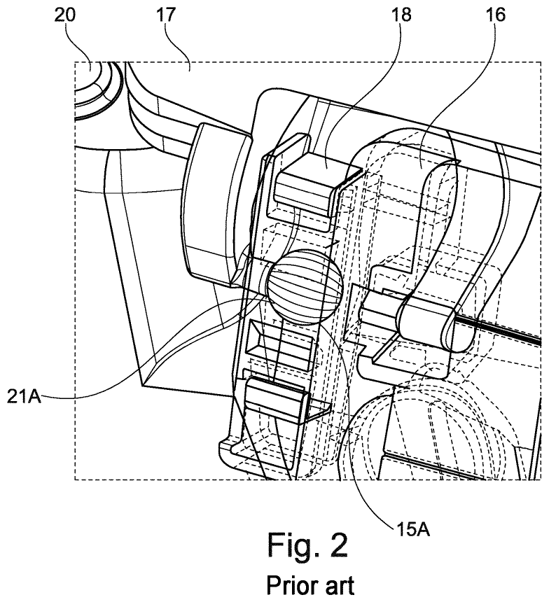

FIG. 2 shows an enlarged detail of the reflection device from FIG. 1 in the area of the first, left-hand bearing,

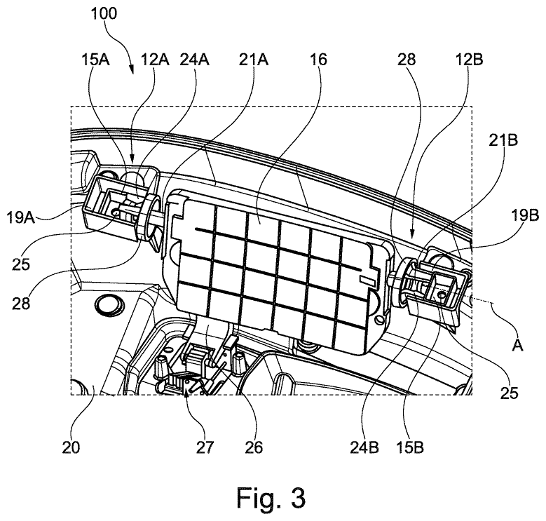

FIG. 3 is a perspective view of components of an exemplary embodiment of a reflection device according to the present invention in an installation state in a vehicle according to the invention,

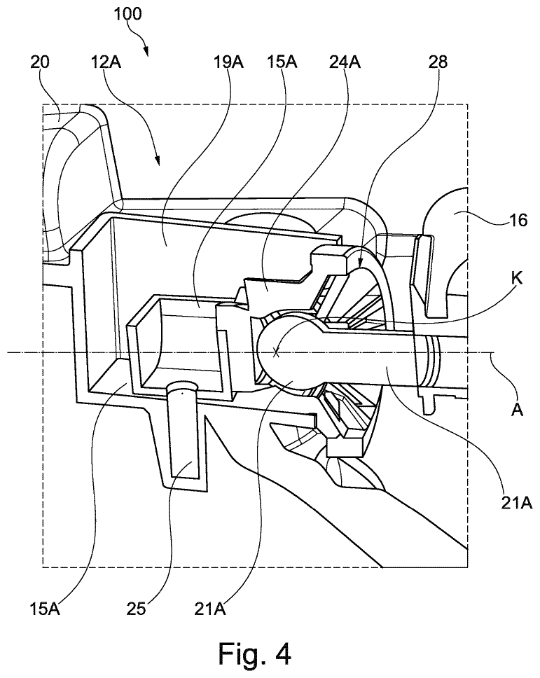

FIG. 4 shows an enlarged detail of the reflection device from FIG. 3 in the area of the first, left-hand bearing and

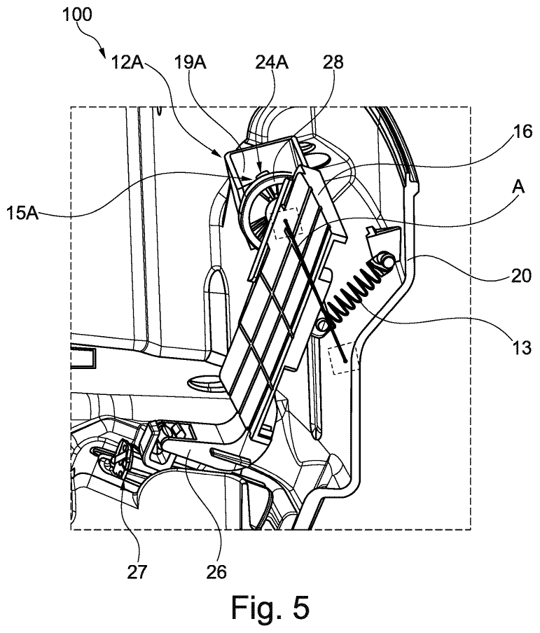

FIG. 5 is a sectional view in the longitudinal direction of the vehicle through the reflection device in FIG. 3.

FIG. 1 shows a perspective view of a section of a reflection device 1 known from the prior art, which is part of an unspecified head-up display for a vehicle, wherein the reflection device 1 is designed for a windshield head-up display and comprises a curved and concave reflection element 11 with a reflection side 22 and a rear side 23. The reflection element 11 is pivotable about a first axis A, which is defined by a first, left-hand bearing 12A and a second, right-hand bearing 12B.

As can be clearly seen in conjunction with the enlarged representation in FIG. 2, the bearings 12A and 12B each comprise a bearing receptacle 15A, 15B and a bearing journal 21A, 21B with a spherical end, which extends along the pivot axis A and is held in the associated bearing receptacle 15A, 15B by means of a securing element 18.

In this exemplary embodiment from the prior art, the bearing journal 21A, 21B is in each case attached to a mount 17, which in turn is attached to a surrounding housing 20 of an associated head-up display. The bearing retainers 15A, 15B are each attached to a support structure 16, which holds the reflection element 11. For this purpose, the reflection element 11 is attached to the support structure 16 with its rear side 23.

The support structure 16 is coupled to a linear pivot drive unit 27, in this case a stepper motor 27, via a pivot arm 26. The pivot drive 27 can be used to pivot the reflection element 11 about the first axis A or the pivot axis A.

FIG. 3 shows a perspective view of several components of an exemplary embodiment of a reflection device 100 according to the present invention for an unspecified head-up display according to the present invention in an installation state in a vehicle according to the invention which is not specified here, wherein the reflection device 100 according to the invention is shown in this representation without the associated, curved and concave reflection element 11, which in particular is similar or identical to the reflection element 11 of FIG. 1.

To receive and hold the reflection element 11, the reflection device 100 also has a corresponding support structure 16, which is also coupled via a pivot arm 26 to a linear pivot drive unit 27 in the form of a linear stepper motor 27. The reflection element 11, which is not shown here, can be attached to the support structure 16 with its rear side 23, in particular in a manner known from the prior art (see FIG. 1).

With the aid of the linear pivot drive unit 27 and the pivot arm 26, the support structure 26 and subsequently also a reflection element 11 attached to it can be pivoted about the first axis A.

The reflection device 100 also has two bearings 12A and 12B for rotatably mounting the support structure 16 or the reflection element 11 about the first axis A. The bearings 12A and 12B each comprise a bearing journal 21A and or 21B as well as a bearing retainer 15A or 15B for receiving the bearing journals 21A or 21B. In this exemplary embodiment, the bearing journals 21A and 21B are each fixed, i.e., stationary and immovable, to the support structure 16, while the bearing retainers 15A and 15B are each immovable and thus fixed to the housing 20, wherein the bearing retainers 15A and 15B are in particular integrally formed with the housing 20. In this head-up display or this reflection device 100, the housing 20 thus assumes the function of the mount 17 in FIGS. 1 and 2 and accordingly has mount retainers 19A and 19B for receiving the bearing retainers 15A and 15B.

The bearing journals 21A and 21B each have a spherical end with an at least partially spherical outer surface, which is designed as a bearing surface in each case. The associated bearing retainers 15A and 15B are each designed to at least partially receive the bearing journals 21A and 21B and, as can be clearly seen from FIG. 4, have an unspecified, at least partially concave spherical inner surface which corresponds to the spherical outer surface of the bearing journals 21A and 21B.

As can also be clearly seen from FIG. 4, the bearing retainers 15A and 15B each have a spring element 24A, which in this exemplary embodiment is formed integrally with the associated bearing retainer 15A or 15B. These bearing retainers 15A and 15B are each inserted from above (in relation to the illustration) into the mount retainers 19A and 19B and can be fixed in these by means of a screw connection via a bore 25 with an internal thread, which is only schematically indicated here.

The two bearings 12A and 12B are substantially identical in design, wherein in particular the two spring elements 24A and 24B, which each receive and guide the bearing journal 21A and 21B respectively, are of identical design. The bearings 12A and 12B each have kinematic points K, wherein the two kinematic points K of the bearings 12A and 12B define the first axis A about which the reflection element or the support structure 16 is rotatable relatively vis-à-vis the housing 20.

The spring elements 24A and 24B are each designed as a cage-like spring cage and allow at least partial insertion of the associated bearing journal 21A or 21B into the cage volume for receiving and guiding the bearing journal 21A or 21B.

The spring effect is achieved in each case by a part or plate-spring-like section 28, which extends with a “plate plane” substantially perpendicular to the first axis A.

The bearing journals 21A and 21B of the bearings 12A and 12B project at least partially into the associated spring cage 24A or 24B of the associated bearing retainer 15A or 15B and are in engagement with the spring cage 24A or 24B in such a way that a spring force can be generated by an axial displacement of the bearing journal 21A or 21B along the first axis A in at least one direction, starting from at least one reference position.

In this exemplary embodiment, the spring elements 24A and 24B are preferably made of plastic, in particular of a solid plastic such as polyamide or the like, in order to achieve sufficient bearing rigidity for secure positioning and guidance of the bearing journals 21A and 21B and thus of the support structure 16 and the reflection element. With such a spring element 24A or 24B, which takes over both the guidance of the bearing journal 21A or 21B as well as a spring support function, a mounting of a reflection element 11 or an associated support structure 16 in a head-up display can be realized in a particularly cost-effective and space-saving manner, in particular with preload forces in the range of about 100 N.

As can be seen from FIG. 5, which shows a sectional view in the longitudinal direction of the vehicle through the reflection device of FIG. 3 viewed from the side (with reference to a functional installation state in a vehicle), at least one preload element 13 can also be provided in order to achieve better and more secure positioning of the support structure 16 and thus of the reflection element (not shown here), which in this exemplary embodiment is designed as a spiral spring 13 and in this case only acts on the support structure 16 and thus the mounting in one plane. Alternatively, the pre-tensioning element 13 can also be arranged in space in such a way that a pre-tensioning force is applied in several spatial directions simultaneously.

In addition to the embodiments described and shown and the possible embodiments described, a number of further embodiments are possible without leaving the scope of protection defined by the claims.

### List of Reference Signs:

1 Exemplary embodiment of a reflection device from the prior art
100 Exemplary embodiment of a reflection device according to the present invention 11 Reflection element
12A First (left-hand) bearing
12B Second (right-hand) bearing
13 Preload element
15A First (left-hand) bearing retainer
15A Second (right-hand) bearing retainer
16 Support structure
17 Mount
18 Securing element
19A, 19B Mount retainer
20 Housing
21A First (left-hand) bearing journal
21A Second (right-hand) bearing journal
22 Reflection side of the reflection element
23 Rear side of the reflection element
24A First (left-hand) spring element
24B Second (right-hand) spring element
25 Through hole for screw connection
26 Coupling means for coupling the support structure to a (linear) pivot drive unit
27 Linear pivot drive unit
28 Plate-spring-like area
A First axis
K Kinematic point of the bearing

1. A reflection device for a head-up display for reflecting radiation emitted by an image generation unit, wherein the reflection device comprises:
a reflection element which has a reflection side and a rear side which is arranged on the side facing away from the reflection side, and
a mount which at least partially supports the reflection element,
wherein the reflection element is movably coupled to the mount by means of at least one bearing in such a way that the reflection element is pivotable about at least a first axis relatively vis-à-vis the mount and
wherein at least one bearing comprises at least two parts: a bearing journal and a bearing retainer for receiving the bearing journal,
wherein the bearing journal has an at least partially convexly spherical, spherical and/or hemispherical outer surface or a spherical end or a spherical surface or the like as a bearing surface,
wherein the bearing retainer is designed to at least partially receive the bearing journal,
wherein one of the parts, the bearing journal or the bearing retainer, is fixed immovably to the reflection element and the other part, the bearing retainer or the bearing journal, is immovably attached to the mount
wherein the bearing retainer has a spring element or is at least partially designed as a spring element and
wherein the spring element of the bearing retainer is or has a spring cage or is designed in the style of a spring cage.

2. The reflection device as claimed in claim 1, wherein the reflection element is rotatably coupled to the mount by at least two bearings: a first bearing and a second bearing,
wherein each bearing has a kinematic point and the kinematic points of the bearings define the first axis about which the reflection element is rotatable relatively vis-à-vis the mount, and
wherein the first bearing and the second bearing each comprise two parts: a bearing journal and a bearing retainer for receiving the bearing journal,
wherein each bearing journal each has an at least partially convexly spherical, spherical and/or hemispherical outer surface or a spherical end or a spherical surface or the like as a bearing surface,
wherein the bearing retainer is designed to at least partially receive the bearing journal,
wherein one of the parts, the bearing journal or the bearing retainer is in each case immovably attached to the reflection element and the other part, the bearing retainer or the bearing journal, is in each case immovably attached to the mount,
wherein the bearing retainer has a spring element in each case or is at least partially formed as a spring element, and
wherein the spring element of the bearing retainer is or comprises a spring cage or is designed in the style of a spring cage.

3. The reflection device as claimed in claim 1, wherein at least one spring cage has a main springing direction and is arranged in the bearing holder in such a way that its main springing direction is aligned with the first axis about which the reflection element is pivotable.

4. The reflection device as claimed in claim 1, wherein at least one spring element has or is a conical spiral spring.

5. The reflection device as claimed in claim 1, wherein at least one spring element has or is at least one plate spring or is a plate-spring-like spring element or is at least partially designed in the style of a plate spring, wherein such a spring element is arranged such that an associated plate plane extends substantially in the radial direction perpendicular to the axis of rotation of the reflection element.

6. The reflection device as claimed in claim 1, wherein the bearing journal of at least one bearing projects at least partially into the associated spring cage of the associated bearing retainer and is engaged, can be engaged, or is coupled with the spring cage in such a way that a spring force can be generated by an axial displacement of the bearing journal along the first axis in at least one direction, starting from at least one position.

7. The reflection device as claimed in claim 6, wherein at least one bearing journal of a bearing is inserted into the associated spring cage in the axial direction of the first axis.

8. The reflection device as claimed in claim 1, wherein at least one bearing retainer is received by the mount, wherein the mount has a mount retainer for this purpose, into which the bearing retainer is inserted.

9. The reflection device as claimed in claim 8, wherein the bearing holder is inserted into the mount retainer by a translatory movement in a plane extending perpendicular to the first axis.

10. The reflection device as claimed in claim 8, wherein the bearing holder is fastened in the mount retainer by means of a screw connection.

11. The reflection device as claimed in claim 1, wherein the reflection device has at least preload means for generating at least one preload force in order to hold the reflection element in a defined position in an assembled state of the reflection device wherein the preload means is arranged in on a rear side of the reflection element.

12. A spring element for a bearing retainer for receiving a reflection element of a reflection device for a head-up display, wherein the reflection device is designed to reflect radiation emitted by an image generation unit, wherein the spring element is designed to produce a reflection device as claimed in claim 1.

13. A bearing retainer for receiving a reflection element of a reflection device for a head-up display, wherein the reflection device is designed to reflect radiation emitted by an image generation unit, wherein the bearing retainer is designed to produce a reflection device as claimed in one of claim 1.

14. A head-up display, comprising an image generation unit for emitting light beams in order to generate an image, and comprising at least one reflection device for reflecting the light beams emitted by the image generation unit, wherein the reflection device is designed as claimed in claim 1.

15. A motor vehicle which has a head-up display, wherein the head-up display is designed as claimed in claim 14.
